(19) United States
(12) Patent Application Publication
(10) Pub. No.: US 2006/0291420 A1
(43) Pub. Date: Dec. 28, 2006

(54) Network-initiated dormant handoffs

(76) Inventor: Dennis Ng, Northboro, MA (US)

Correspondence Address: FISH & RICHARDSON PC, P.O. BOX 1022, MINNEAPOLIS, MN, 55440-1022, US

(21) Appl. No.: 11/167,785

(22) Filed: Jun. 27, 2005

(51) Int. Cl. H04Q 7/00; H04L 12/56

(52) U.S. Cl. 370/331; 370/400

(57) ABSTRACT

In a radio access network having a first mesh cluster and a second mesh cluster, techniques for enabling an access terminal in a coverage area of the first mesh cluster to maintain a session through a radio node of the first mesh cluster with at least one radio node controller of the second mesh cluster. In a radio access network having a mesh cluster of groups of radio nodes and radio node controllers, techniques for defining a relationship between a pair of groups, the relationship being a neighboring relationship or a non-neighboring relationship, and enabling a radio node of a group to identify a destination radio node controller of a packet received from an access terminal, and to selectively route the packet to a radio node controller based on the relationship between the group of the radio node and the group of the destination radio node controller.

### CROSS-REFERENCE TO RELATED APPLICATIONS

This application is related to U.S. application Ser. Nos. 11/037,896 filed on Jan. 18, 2005, 09/891,103, filed on Jun. 25, 2001, and 10/848,597, filed May 18, 2004.

### TECHNICAL FIELD

This description relates to network-initiated dormant handoffs.

High Data Rate (HDR) is an emerging mobile wireless access technology that enables personal broadband Internet services to be accessed anywhere, anytime (see P. Bender, et al., “CDMA/HDR: A Bandwidth-Efficient High-Speed Wireless Data Service for Nomadic Users”, IEEE Communications Magazine, July 2000, and 3GPP2, “Draft Baseline Text for 1×EV-DO,” Aug. 21, 2000). Developed by Qualcomm, HDR is an air interface optimized for Internet Protocol (IP) packet data services that can deliver a shared forward link transmission rate of up to 2.46 Mbit/s per sector using only (1X) 1.25 MHz of spectrum. Compatible with CDMA2000 radio access (TIA/EIA/IS-2001, “Interoperability Specification (IOS) for CDMA2000 Network Access Interfaces,” May 2000) and wireless IP network interfaces (TIA/EIA/TSB-115, “Wireless IP Architecture Based on IETF Protocols,” Jun. 6, 2000, and TIA/EIA/IS-835, “Wireless IP Network Standard,” 3^{rd} Generation Partnership Project 2 (3GPP2), Version 1.0, Jul. 14, 2000), HDR networks can be built entirely on IP technologies, all the way from the mobile Access Terminal (AT) to the global Internet, thus taking full advantage of the scalability, redundancy and low-cost of IP networks.

HDR has been adopted by TIA (Telecommunications Industry Association) as a new standard in the CDMA2000 family, an EVolution of the current 1×RTT standard for high-speed data-only (DO) services, formally referred to as HRPD (High Rate Packet Data), also known as 1×EV-DO (or TIA/EIA/IS-856, “cdma2000® High Rate Packet Data Air Interface Specification,” November 2000).

A 1×EV-DO radio access network (RAN) includes access terminals in communication with radio nodes over airlinks. Each access terminal may be a laptop computer, a Personal Digital Assistant (PDA), a dual-mode voice/data handset, or another device, with built-in 1×EV-DO support. The radio nodes are connected to radio node controllers over a backhaul network that can be implemented using a shared IP or metropolitan Ethernet network which supports many-to-many connectivity between the radio nodes and the radio node controllers. The radio access network also includes a packet data serving node, which is a wireless edge router that connects the RAN to the Internet.

The radio node controllers and the radio nodes of the radio access network can be grouped into radio node controller clusters. The footprint of each radio node controller cluster defines a single 1×EV-DO subnet. In other words, all radio nodes served by the radio node controller cluster belong to the same subnet. Each radio node in the subnet is primarily associated with one radio node controller in the cluster. This association is established when a radio node discovers its radio node controllers.

When every radio node in a cluster is associated with every radio node controller in the cluster, such a cluster is referred to as a mesh cluster. Inside a mesh cluster, an access terminal can always maintain connectivity to its serving radio node controller, since the serving radio node controller can communicate with the access terminal via any one of the radio nodes in the mesh cluster. This means that the serving radio node controller can page the access terminal anywhere inside the mesh cluster, and the access terminal can send an access channel message to its serving radio node controller anywhere inside the mesh cluster.

When a radio node does not have an association with one or more radio node controllers in a cluster, the cluster is referred to as a partially-connected cluster. In a partially-connected cluster, an access terminal can lose network connectivity if the radio node currently serving it does not have an association with its serving radio node controller (i.e. where the wireless session is presently located). In such a case, the access terminal may become unreachable or it may not be able to send access channel messages to its serving radio node controller (for example, to request a new connection). To prevent this from happening, the access terminal's session is transferred from the serving radio node controller to a radio node controller that has an association with the serving radio node, so that the access terminal can maintain connectivity. This transfer process is referred to as a dormant handoff.

A dormant handoff can be initiated by an access terminal. Every time an access terminal crosses a subnet boundary, the access terminal initiates a dormant handoff by sending a UATI_Request message to the serving radio node's network. The access terminal recognizes the need for a dormant handoff by monitoring the unique 128-bit SectorID being broadcast by each sector. All sectors that belong to the same subnet have SectorID's that fall within a common range. This common range identifies a subnet. The 128-bit Universal Access Terminal Identifier (UATI) assigned to each access terminal in a given subnet falls within the same range. When the access terminal moves into the coverage area of another subnet, the access terminal compares its UATI with the SectorID being broadcast by its serving sector. When these do not belong to the same range, the access terminal knows that it has crossed a subnet boundary and initiates a dormant handoff by sending a UATI_Request message to its serving radio node.

A dormant handoff can also be initiated by the network to transfer an access terminal's session from a source radio node controller to a target radio node controller when both are within the same subnet. This can be used to either maintain connectivity in a partially-connected cluster, or reduce the backhaul delay in a mesh cluster by using a serving radio node controller that is closer to the serving radio node. For example, if the access terminal is within the coverage of a serving radio node that does not have an association with the serving radio node controller, its session must be transferred to a new radio node controller that has an association with the serving radio node in order to maintain connectivity. In this case, the network initiates the dormant handoff as the access terminal does not recognize the need for a dormant handoff because it has not crossed a subnet boundary.

A dormant handoff can also be used to reduce the backhaul delay within a mesh cluster by using a serving radio node controller that is closer to the serving radio node. Although a dormant handoff is not necessary in this case due to the full mesh connectivity of the cluster (i.e., every serving radio node is associated with every serving radio node controller), a dormant handoff can be useful for the purpose of selecting a new serving radio node controller (e.g., in a different central office) that is closer to the serving radio node.

Network resources and airlink usage may be wasted when an access terminal's session is repeatedly transferred between multiple radio node controllers as the radio frequency channel conditions sway to favor one serving radio node over another.

### SUMMARY

In one aspect, in a radio access network including a first mesh cluster and a second mesh cluster, the invention features a method for enabling an access terminal in a coverage area of the first mesh cluster to maintain a session through a radio node of the first mesh cluster with at least one radio node controller of the second mesh cluster.

Implementations of the invention may include one or more of the following. The method for enabling includes providing the radio node of the first mesh cluster with information sufficient to enable the radio node to transmit a packet received from the access terminal to the at least one radio node controller of the second mesh cluster. The method for enabling includes providing access by the radio node to a radio node controller identifier for the radio node controller of the second mesh cluster. The radio node controller identifier can include a colorcode.

The method further includes the radio node of the first mesh cluster receiving a packet from the access terminal, selecting a radio node controller, and transmitting the packet to the selected radio node controller. The method for selecting includes examining the packet to determine whether its destination is a radio node controller with which the radio node of the first mesh cluster is associated, and if so, selecting an associated radio node controller based on a radio node controller identifier provided by the packet, and if not, selecting an associated radio node controller based on a load-balancing algorithm. The packet can be transmitted to the selected associated radio node controller so as to initiate a dormant handoff of the session of the access terminal from a serving radio node controller to the selected radio node controller.

In another aspect, in a radio access network including a mesh cluster of groups of radio nodes and radio node controllers, the invention features a method including defining a relationship between a pair of groups, the relationship being a neighboring relationship or a non-neighboring relationship, and enabling a radio node of a group to identify a destination radio node controller of a packet received from an access terminal, and to selectively route the packet to a radio node controller based on the relationship between the group of the radio node and the group of the destination radio node controller.

Implementations of the invention may include one or more of the following. If the destination radio node controller and the radio node are in the same group or in neighboring groups, the method includes routing the packet to the destination node controller. If the destination radio node controller and the radio node are in non-neighboring groups, the method includes routing the packet to a radio node controller in the group of the radio node so as to initiate a dormant handoff of the session of the access terminal from the destination radio node controller. The packet includes a destination node controller identifier. The destination node controller identifier includes a colorcode.

The enabling includes identifying the group of the destination radio node controller from the colorcode, and determining a relationship between the group of the destination radio node controller and the group of the radio node. The destination node controller identifier includes a group identifier. The enabling includes identifying the group of the destination radio node controller from the group identifier, and determining a relationship between the group of the destination radio node controller and the group of the radio node.

The radio nodes can be associated with all of the radio node controllers of the mesh cluster. The radio nodes can be primarily associated with the radio node controllers of its group.

In another aspect, the invention features a radio access network including a first mesh cluster and a second mesh cluster, the first mesh cluster including a radio node that is associated with at least one radio node controller of the second mesh cluster such that an access terminal in a coverage area of the first mesh cluster is able to maintain a session through the radio node of the first mesh cluster with the at least one radio node controller of the second mesh cluster.

Implementations of the invention may include one or more of the following. The second mesh cluster includes a radio node that is associated with at least one radio node controller of the first mesh cluster such that an access terminal in a coverage area of the second mesh cluster is able to maintain a session with the at least one radio node controller of the first mesh cluster. The radio node of the first mesh cluster is associated with all of the radio node controllers of the first mesh cluster. The radio node of the first mesh cluster is associated with all of the radio node controllers of the second mesh cluster. The coverage area of each mesh cluster is defined by coverage areas of its respective radio nodes. The first mesh cluster and the second mesh cluster form a partially-connected cluster of the radio access network. The radio node of the first mesh cluster is located near a geographic boundary between the first mesh cluster and the second mesh cluster. The radio access network includes a code division multiple access network. The radio access network includes a first evolution-data optimized or a first evolution-data/voice compliant network.

In another aspect, the invention features a radio access network including a mesh cluster of groups of radio nodes and radio node controllers, each pair of groups having a neighboring relationship or a non-neighboring relationship, wherein a radio node of a group is enabled to identify a destination radio node controller of a packet received from an access terminal, and to selectively route the packet to a radio node controller based on the relationship between the group of the radio node and the group of the destination radio node controller.

Implementations of the invention may include one or more of the following. A pair of adjacent groups have a neighboring relationship. A pair of non-adjacent groups separated by fewer than N number of groups, where N is a positive integer greater than zero, have a neighboring relationship.

Advantages that can be seen in particular implementations of the invention include one or more of the following. By including overlap radio nodes in a partially-connected cluster, an access terminal that is located in an area that straddles the boundaries or borders between two mesh clusters is able to maintain its network connectivity without having its session repeatedly bounce between two radio node controllers in different mesh clusters based on which radio node is serving the access terminal. The overlap radio nodes provide a greater range of movement by the access terminal before a dormant handoff has to be initiated by a radio node controller. By restricting network-initiated dormant handoffs to occur only in the event that an access terminal moves beyond a buffer region between two mesh clusters, or in other cases a session transfer between two non-neighboring radio node controller groups within a mesh cluster, the frequency at which an access terminal's session is transferred between multiple radio node controllers is reduced. This in turn reduces the backhaul delay in cases where the serving radio node is closer to the new radio node controller than the one presently serving the session, maximizes the available network resources by not using them for unnecessary session transfers, reduces airlink usage of the radio access network, and minimizes unnecessary session transfers.

The details of one or more examples are set forth in the accompanying drawings and the description below. Further features, aspects, and advantages of the invention will become apparent from the description, the drawings, and the claims.

### DESCRIPTION OF DRAWINGS

FIGS. 1 and 2 show radio access networks.

### DETAILED DESCRIPTION

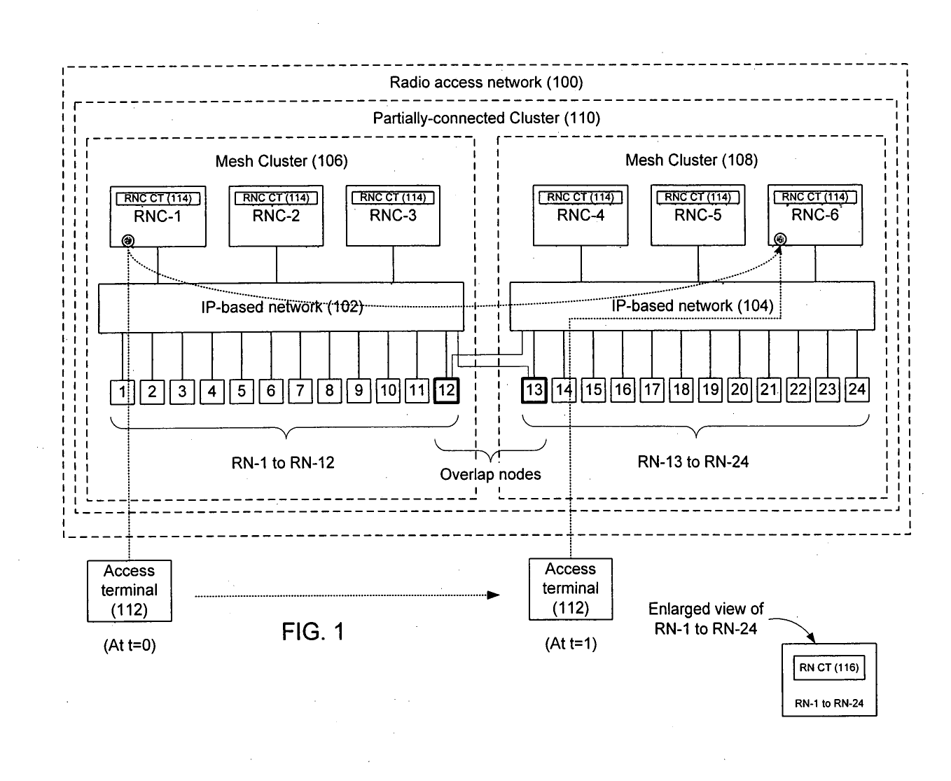

FIG. 1 shows a radio access network 100 with six radio node controllers (RNC-1 to RNC-6) connected to twenty-four radio nodes (RN-1 to RN-24) over two IP-based networks 102, 104. The radio node controllers and radio nodes are grouped into two mesh clusters 106, 108, which together form a partially-connected cluster 110 within a single 1×EV-DO subnet. Other partially-connected clusters (not shown) can be included in the radio access network 100.

In the illustrated example of FIG. 1, the radio node controllers and radio nodes are equally divided between the two mesh clusters 106, 108. Each radio node is associated with the radio node controllers in its mesh cluster 106, 108, and one radio node (e.g., RN-12 and RN-13) from each mesh cluster 106, 108 is further associated with the radio node controllers of the other mesh cluster 106, 108. Radio nodes that are associated with radio node controllers of multiple clusters 106, 108 are referred to in this description as overlap radio nodes (e.g., RN-12 and RN-13). The overlap radio nodes (e.g., RN-12 and RN-13) are generally located at the geographic boundaries or borders between two mesh clusters 106, 108. Any number of overlap radio nodes can be included in the partially-connected cluster 110 so long as the radio node controllers of the partially-connected cluster 110 are capable of supporting the additional radio nodes. The overlap radio nodes (e.g., RN-12 and RN-13) provide a common buffer region between the two mesh clusters 106, 108 that reduces or minimizes the ping-pong effects that occur when an access terminal 112 moves between the two mesh clusters 106, 108.

In some implementations, each radio node controller in the radio access network 100 is assigned an 8-bit colorcode (e.g., as defined in the TIA/EIA/IS-856 specification) by the network operator that corresponds to a locally unique identifier of the radio node controller. Although the same 8-bit colorcode can be assigned to multiple radio node controllers in the radio access network 100, provisions are made to ensure that a particular colorcode is assigned to only one radio node controller per mesh cluster 106, and not used by any neighboring mesh cluster. In addition, provisions are made to ensure that neighbors of a mesh cluster 106 do not repeat any common colorcode amongst them.

Each radio node controller includes (or has access to) a colorcode table (“RNC colorcode table” 114) that identifies the colorcode assignments for all radio node controllers within its partially-connected cluster 110, as well as some other radio node controllers that are not members of this partially-connected cluster 110. The RNC colorcode table 114 contains, amongst other things, the IP address of each of the radio node controllers from which it can retrieve a session, e.g., using the A13 protocol. This identifies the address of the serving radio node controller that uses a particular colorcode. When a radio node controller assigns a new Universal Access Terminal Identifier (UATI) to an access terminal 112, that radio node controller becomes the access terminal's serving radio node controller on which a 1×EVDO session resides. In some implementations, the assigned UATI includes a 32-bit address structure having information in two fields: a colorcode field and a per-user assigned field. The colorcode field includes 8 bits of information that corresponds to the serving radio node controller's assigned colorcode. The per-user assigned field includes 24 bits of information that corresponds to a unique identification of the user session within the radio node controller.

Each radio node includes (or has access to) a colorcode table (“RN colorcode table” 116) that identifies the colorcode assignments for all of the radio node controllers within its mesh cluster 106, 108. The overlap radio nodes (e.g., RN-12 and RN-13) further include in their respective RN colorcode tables 116 the colorcode assignments for all of the radio node controllers in the other mesh cluster 106, 108. In this manner, each radio node has a RN colorcode table 116 that identifies the colorcode assignments for all the radio node controllers with which the radio node is associated. The RN colorcode table 116 contains the IP address of each of the radio node controllers with which it is associated. This identifies the radio node controller destination address to send packets (e.g., received from the access terminal 112) addressed with a particular UATI colorcode.

When a servicing radio node (i.e., a radio node whose airlink the access terminal is requesting service from) receives an access channel packet from an access terminal 112, the serving radio node uses the packet's UATI colorcode information and the RN colorcode table 116 to route the packet to its serving radio node controller. If, however, the serving radio node receives a packet having a UATI colorcode that is not in the RN colorcode table 116, this indicates to the serving radio node that the serving radio node controller is not an associated radio node controller, and routes the packet to one of its associated radio node controllers instead. Typically, the packet is routed to an associated radio node controller in the same mesh cluster as the serving radio node. In some examples, the selection of radio node controller is made in accordance with some load-balancing mechanism.

As an example, suppose that at time t=0, the serving radio node controller for the access terminal 112 is RNC-1. So long as the access terminal 112 stays within the coverage area of RN-1 through RN-13, the serving radio node (i.e., one of RN-1 through RN-13) routes all access channel packets received from the access terminal 112 to its serving radio node controller (i.e., RNC-1).

At time t=0, the access terminal 112 moves into the coverage area of RN-14 through RN-24, and the serving radio node (i.e., one of RN-14 through RN-24) receives an access channel packet from the access terminal 112. The serving radio node (e.g., RN-14) does not have an association with the access terminal's serving radio node controller (i.e., RNC-1) or any of the radio node controllers in the mesh cluster 106. In such a scenario, the serving radio node RN-14 selects one of the radio node controllers (i.e., one of RNC-4 through RNC-6) within its mesh cluster 108, and routes the access channel packet to the selected radio node controller (e.g., RNC-6). In some examples, the selection of radio node controller is made in accordance with some load-balancing mechanism.

The selected radio node controller RNC-6 buffers the access channel packet and uses the packet's UATI colorcode information and the RNC colorcode table 114 to identify the access terminal's serving radio node controller (e.g., RNC-1). The selected radio node controller RNC-6 initiates a dormant handoff (in this case, a A13 dormant handoff) from the serving radio node controller RNC-1 to retrieve the access terminal's session. For the purposes of the dormant handoff, the selected radio node controller RNC-6 assumes the role of a target radio node controller and the serving radio node controller RNC-1 assumes the role of a source radio node controller.

To initiate a A13 dormant handoff, the target radio node controller RNC-6 sends a A13-Session Information Request message to the source radio node controller RNC-1 via the two IP-based networks 104, 102. The source radio node controller RNC-1 responds with a A13-Session Information Response message to transfer the session information for the access terminal to the target radio node controller RNC-6. Upon receipt of the A13-Session Information Response message, the target radio node controller RNC-6 sends a A13-Session Information Confirm message to the source radio node controller RNC-1 to command it to remove the transferred session from its database.

The target radio node controller RNC-6 then assumes the role of the serving radio node controller for the access terminal 112 and processes the packet that was previously-buffered. The serving radio node controller RNC-6 also assigns a new UATI to the access terminal 112. This newly-assigned UATI includes information in the colorcode field that corresponds to the colorcode assigned to the serving radio node controller RNC-6. From this time onwards, so long as the access terminal 112 stays within the coverage area of RN-12 through RN-24, the access terminal 112 maintains a session with the serving radio node controller RNC-6 and access channel packets received by a serving radio node (i.e., one of RN-12 through RN-24) are routed to the serving radio node controller (i.e., RNC-6).

By including overlap radio nodes such as RN-12 and RN-13 in the partially-connected cluster 110, an access terminal 112 that is located in an area that straddles the boundaries or borders between two mesh clusters 106, 108 is able to maintain its network connectivity without having its session repeatedly bounce between two radio node controllers in different mesh clusters based on which radio node is serving the access terminal 112. Although the illustrated example of FIG. 1 includes only two overlap radio nodes, any number of overlap radio nodes may be included to provide a greater range of movement by the access terminal 112 before dormant handoff has to be initiated by a radio node controller.

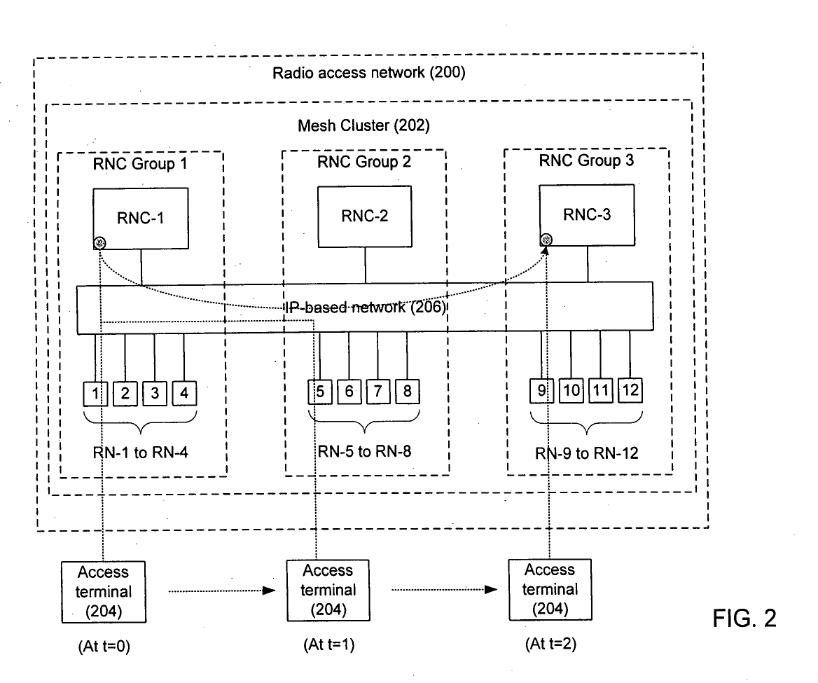

FIG. 2 shows a radio access network 200 with three radio node controllers (RNC-1 to RNC-3) connected to twelve radio nodes (RN-1 to RN-12) over a single IP-based network 206. The radio node controllers and radio nodes form a mesh cluster 202 within a single 1×EV-DO subnet.

In the illustrated example of FIG. 2, the radio node controllers and radio nodes are equally divided between three radio node controller groups (RNC Group 1 to RNC Group 3) but the division need not be equal. The groups are visually depicted as being contiguous, where RNC Group 2 is physically located between RNC Groups 1 and 3. In some implementations, groups that are adjacent to each other and not separated by any other RNC group are considered to be “neighboring RNC groups.” For example, in the case of FIG. 2, there are two sets of neighboring RNC groups: set A includes RNC groups 1 and 2 and set B includes RNC groups 2 and 3. In other implementations, groups that are separated by fewer than N number of groups (where N is a fixed positive integer greater than 0) are considered to be “neighboring RNC groups.”

Each radio node includes (or has access to) a RNC group table that includes RNC Group identifiers, each identifying the RNC group to which a radio node controller in the mesh cluster is assigned. The RNC Group identifier of each radio node controller is encoded in the UATI that it assigns to sessions it serves. In some implementations, the RNC group identifier is part of the UATI colorcode information. In other implementations, the RNC group identifier is separate from the UATI colorcode information. When a radio node receives a packet from the access terminal 204, it determines the serving RNC Group of access terminal 204 from the UATI of the packet.

As an example, suppose that at time t=0, the serving radio node controller for an access terminal 204 is RNC-1. So long as the access terminal 204 stays within the coverage area of RN-1 through RN-4, the serving radio node (e.g., RN-1) routes all access channel packets received from the access terminal 204 to its serving radio node controller (i.e., RNC-1).

At time t=1, the access terminal 204 moves into the coverage area of RN-5 through RN-8 and the serving radio node (e.g., RN-5) receives an access channel packet from the access terminal 204. The serving radio node RN-5 uses the packet's UATI information and the RNC group table to identify the serving radio node controller (in this case RNC-1). As the serving radio node RN-5 and the serving radio node controller RNC-1 are in neighboring RNC groups (namely RNC Groups 1 and 2), the serving radio node RN-5 routes the access channel packet to the serving radio node controller RNC-1.

At time t=2, the access terminal 204 moves into the coverage area of RN-9 through RN-12. The serving radio node (e.g., RN-9) receives an access channel packet from the access terminal 204 and identifies the serving radio node controller as being RNC-1. As the serving radio node RN-9 and the serving radio node controller RNC-1 are in non-neighboring RNC groups, the serving radio node RN-9 routes the access channel packet to the radio node controller (i.e., RNC-3) in its RNC group. Upon receipt of the access channel packet, the radio node controller RNC-3 buffers the packet and initiates a dormant handoff (e.g., in the manner previously-described) to retrieve the access terminal's session from the serving radio node controller RNC-1.

Once the session has been successfully transferred to the radio node controller RNC-3, that radio node controller RNC-3 assumes the role of the serving radio node controller for the access terminal 204 and processes the packet that was previously-buffered. The serving radio node controller RNC-6 also assigns a new UATI to the access terminal 204. This newly-assigned UATI includes information in the colorcode and RNC Group identifier fields that corresponds to the colorcode and RNC Group identifier respectively, assigned to the serving radio node controller RNC-3. From this time onwards, so long as the access terminal 204 stays within the coverage area of RN-5 through RN-12, the access terminal 204 maintains a session with the serving radio node controller RNC-3 and access channel packets received by a serving radio node (i.e., one of RN-5 through RN-12) are routed to the serving radio node controller (i.e., RNC-3) without triggering a network-initiated dormant handoff.

By restricting network-initiated dormant handoffs to occur only in the event of a session transfer between two non-neighboring RNC groups, the frequency at which an access terminal's session is transferred between multiple radio node controllers is reduced. This in turn reduces the backhaul delay in cases where the serving radio node is closer to the new radio node controller than the one presently serving the session, maximizes the available network resources by not using them for unnecessary session transfers, reduces airlink usage of the radio access network, and minimizes unnecessary session transfers.

A number of embodiments of the invention have been described. Nevertheless, it will be understood that various modifications may be made without departing from the spirit and scope of the invention, and, accordingly, other embodiments are within the scope of the following claims. In some examples, the target radio node controller uses a procedure other than a A13 dormant handoff procedure to retrieve a session from the source radio node controller. In other examples, a serving radio node uses information provided in the UATI (i.e., other than the UATI colorcode) to identify the radio node controller that is currently serving the access terminal.

What is claimed is:

1. A method comprising:
in a radio access network comprising a first mesh cluster and a second mesh cluster, enabling an access terminal in a coverage area of the first mesh cluster to maintain a session through a radio node of the first mesh cluster with at least one radio node controller of the second mesh controller.

2. The method of claim 1, wherein the enabling comprises:
providing the radio node of the first mesh cluster with information sufficient to enable the radio node to transmit a packet received from the access terminal to the at least one radio node controller of the second mesh cluster.

3. The method of claim 1, wherein the enabling comprises:
providing access by the radio node to a radio node controller identifier for the radio node controller of the second mesh cluster.

4. The method of claim 3, wherein the radio node controller identifier comprises a colorcode.

5. The method of claim 1, further comprising:
the radio node of the first mesh cluster receiving a packet from the access terminal, selecting a radio node controller, and transmitting the packet to the selected radio node controller.

6. The method of claim 5, wherein the selecting comprises:
examining the packet to determine whether its destination is a radio node controller with which the radio node of the first mesh cluster is associated, and if so, selecting an associated radio node controller based on a radio node identifier provided by the packet.

7. The method of claim 6, wherein the radio node controller identifier comprises a colorcode.

8. The method of claim 5, wherein the selecting comprises:
examining the packet to determine whether its destination is a radio node controller with which the radio node of the first mesh cluster is associated, and if not, selecting an associated radio node controller based on a load-balancing algorithm.

9. The method of claim 8, wherein the packet is transmitted to the selected associated radio node controller so as to initiate a dormant handoff of the session of the access terminal from a serving radio node controller to the selected radio node controller.

10. A method comprising:
in a radio access network comprising a mesh cluster of groups of radio nodes and radio node controllers, defining a relationship between a pair of groups, the relationship being a neighboring relationship or a non-neighboring relationship, and enabling a radio node of a group to identify a destination radio node controller of a packet received from an access terminal, and to selectively route the packet to a radio node controller based on the relationship between the group of the radio node and the group of the destination radio node controller.

11. The method of claim 10, wherein, if the destination radio node controller and the radio node are in the same group, the packet is routed to the destination node controller.

12. The method of claim 10, wherein, if the destination radio node controller and the radio node are in neighboring groups, the packet is routed to the destination node controller.

13. The method of claim 10, wherein, if the destination radio node controller and the radio node are in non-neighboring groups, the packet is routed to a radio node controller in the group of the radio node so as to initiate a dormant handoff of the session of the access terminal from the destination radio node controller.

14. The method of claim 10, wherein the packet comprises a destination node controller identifier.

15. The method of claim 14, wherein the destination node controller identifier comprises a colorcode.

16. The method of claim 15, where the enabling comprises:
identifying the group of the destination radio node controller from the colorcode, and
determining a relationship between the group of the destination radio node controller and the group of the radio node.

17. The method of claim 14, wherein the destination node controller identifier comprises a group identifier.

18. The method of claim 17, wherein the enabling comprises:
identifying the group of the destination radio node controller from the group identifier, and
determining a relationship between the group of the destination radio node controller and the group of the radio node.

19. The method of claim 10, wherein the radio nodes are associated with all of the radio node controllers of the mesh cluster.

20. The method of claim 10, wherein the radio nodes are primarily associated with the radio node controllers of its group.

21. A radio access network comprising:
a first mesh cluster and a second mesh cluster, the first mesh cluster including a radio node that is associated with at least one radio node controller of the second mesh cluster such that an access terminal in a coverage area of the first mesh cluster is able to maintain a session through the radio node of the first mesh cluster with the at least one radio node controller of the second mesh cluster.

22. The radio access network of claim 21, wherein the second mesh cluster includes a radio node that is associated with at least one radio node controller of the first mesh cluster such that an access terminal in a coverage area of the second mesh cluster is able to maintain a session with the at least one radio node controller of the first mesh cluster.

23. The radio access network of claim 21, wherein the radio node of the first mesh cluster is associated with all of the radio node controllers of the first mesh cluster.

24. The radio access network of claim 21, wherein the radio node of the first mesh cluster is associated with all of the radio node controllers of the second mesh cluster.

25. The radio access network of claim 21, wherein the coverage area of each mesh cluster is defined by coverage areas of its respective radio nodes.

26. The radio access network of claim 21, wherein the first mesh cluster and the second mesh cluster form a partially-connected cluster of the radio access network.

27. The radio access network of claim 21, wherein the radio node of the first mesh cluster is located near a geographic boundary between the first mesh cluster and the second mesh cluster.

28. The radio access network of claim 21, wherein the radio access network comprises a code division multiple access network.

29. The radio access network of claim 21, the radio access network comprises a first evolution-data optimized or a first evolution-data/voice compliant network.

30. A radio access network comprising:
a mesh cluster of groups of radio nodes and radio node controllers, each pair of groups having a neighboring relationship or a non-neighboring relationship, wherein a radio node of a group is enabled to identify a destination radio node controller of a packet received from an access terminal, and to selectively route the packet to a radio node controller based on the relationship between the group of the radio node and the group of the destination radio node controller.

31. The radio access network of claim 30, wherein a pair of adjacent groups have a neighboring relationship.

32. The radio access network of claim 30, wherein a pair of non-adjacent groups separated by fewer than N number of groups, where N is a positive integer greater than zero, heave a neighboring relationship.
